(19) United States
(12) Patent Application Publication
(10) Pub. No.: US 2009/0228296 A1
(43) Pub. Date: Sep. 10, 2009

(54) OPTIMIZATION OF SOCIAL DISTRIBUTION NETWORKS

(75) Inventor: Emil Ismalon, Tel-Aviv (IL)

Correspondence Address: DARBY & DARBY P.C., P.O. BOX 770, Church Street Station, New York, NY, 10008-0770, US

(73) Assignee: Collarity, Inc., Palo Alto, CA (US)

(21) Appl. No.: 12/397,510

(22) Filed: Mar. 4, 2009

Related U.S. Application Data
(60) Provisional application No. 61/068,153, filed on Mar. 4, 2008.

(51) Int. Cl. G06Q 99/00; G06F 17/30; G06F 7/06

(52) U.S. Cl. 705/1; 707/102; 707/3; 707/E17.014; 707/E17.044

(57) ABSTRACT

A computer-implemented method is provided, which includes labeling an object with one or more object terms that characterize the object. A social graph is constructed that represents an online social network, the social graph having vertices that represent respective members of the social network, and links that represent social connections between respective pairs of the members. Each of the links is tagged with one or more link terms that represent common interests between two of the members whose vertices are connected by the link. Responsively to a comparison of the object terms and the link terms with which the links have been tagged, respective distribution ranks are calculated for a plurality of the members. A message is sent to one of the members of the social network suggesting that the member distribute the object to a subset of the members responsively at least in part to the distribution ranks.

### CROSS-REFERENCE TO RELATED APPLICATIONS

The present application claims the benefit of U.S. Provisional Application 61/068,153, filed Mar. 4, 2008, entitled, “Optimization of social distribution networks,” which is assigned to the assignee of the present application and is incorporated herein by reference.

### FIELD OF THE INVENTION

The present invention relates generally to social networks, and specifically to distribution of applications via social networks.

### BACKGROUND OF THE INVENTION

Social networking websites build online communities of friends, family members, and co-workers, who share common interests or activities. These websites create online representations of real-world relationships, and allow users to interact with each other, such as by sending messages, sharing files, creating personal profiles, and presenting content of interest. Currently popular social networking websites include Facebook, MySpace, and Friendster.

Some social networking websites, such as Facebook, allow third-party developers to create applications that interact with core Facebook features. Users can download these applications into their profiles, and share these applications with other related users. Many such applications rapidly spread virally from user to user, offering commercial opportunities for the entities that develop and distribute them.

US Patent Application Publication 2006/0143081 to Argaiz, which is incorporated herein by reference, describes techniques for evaluating a customer network value of a set of customers for a given marketing campaign. The techniques include storing for each customer static information, collecting for each customer historical and time cumulative network behavior data, building a customer network map from network behavior data, which map describes network relation between nodes, one node representing one customer, computing the social network parameters for the nodes of the network map, selecting the most relevant social network parameters according to the objectives of the given marketing campaign, and, computing for each customer a Customer Network Value Index (NVI) by combining the most relevant social network parameters and static information.

A paper by Kempe D et al., entitled, “Maximizing the spread of influence through a social network,” Conference on Knowledge Discovery in Data archive, Proceedings of the ninth ACM SIGKDD international conference on Knowledge discovery and data mining, Washington, D.C. (2003), which is incorporated herein by reference, describes models for the processes by which ideas and influence propagate through a social network. The authors write, “Recently, motivated by the design of viral marketing strategies, Domingos and Richardson posed a fundamental algorithmic problem for such social network processes: if we can try to convince a subset of individuals to adopt a new product or innovation, and the goal is to trigger a large cascade of further adoptions, which set of individuals should we target?” The authors consider this problem in several of the most widely studied models in social network analysis.

US Patent Application Publication 2007/0191040 to Kadar et al., which is incorporated herein by reference, describes techniques for measuring media distribution and impact in a mobile communication network wherein media content is associated with messages being forwarded in the network. Media content distribution data can be measured and collected by tagging the media content at or near its point of origin and by tracking the tagged media at various points in the network during specific message related events. The collected data is stored and analyzed to determine the effectiveness and impact of media distribution in the mobile communication network.

US Patent Application Publication 2007/0121843 to Atazky et al., which is incorporated herein by reference, describes a method for advertisers to deliver offerings or advertising messages for products or services to a target audience of users selected by a system operator during an advertising campaign. The method includes defining the users within the context of a social network, selecting the users from among the users of the social network, storing the information relevant to the defined users, and utilizing the information stored/defined within the social network to deliver the messages to the users in an optimal manner.

The following patent application publications, all of which are incorporated herein by reference, may be of interest:

US Patent Application Publication 2006/0212355 to Teague et al.

US Patent Application Publication 2008/0004959 to Tunguz-Zawislak et al.

US Patent Application Publication 2005/0273351 to Chudnovsky et al.

US Patent Application Publication 2004/0220850 to Ferrer et al.

US Patent Application Publication 2005/0216338 to Tseng et al.

PCT Publication WO 07/124,430 to Ismalon

US Patent Application Publication 2008/0140643 to Ismalon

US Patent Application Publication 2008/0091670 to Ismalon

US Patent Application Publication 2007/0250500 to Ismalon

US Patent Application Publication 2008/0215416 to Ismalon

### SUMMARY OF THE INVENTION

In some embodiments of the present invention, an application targeting system provides distribution suggestions for increasing the virality of an application or other content for distribution via an online social network, by targeting the application to users most likely to share the application with other users. The system constructs a social graph representing the social network. The social graph has vertices that represent the users, and links, such as edges, that represent social connections between users. The system tags each of the links with one or more terms that represent common interests between the users connected by the link. The system constructs a distribution graph for the application, which comprises a subgraph of the social graph including only those vertices and links of the social graph tagged with at least one of the terms with which the application has been labeled. The system uses the distribution graph to calculate respective distribution ranks for a plurality of the users. The system generates an output suggesting distributing the application to a subset of the users having the greatest distribution ranks, who are likely to be the strongest distributors of the application.

Applications distributed via social networks often include advertising or marketing content. Application developers thus benefit from the wider and more rapid viral distribution such applications enabled by the techniques of embodiments of the present invention.

There is therefore provided, in accordance with an embodiment of the present invention, a computer-implemented method including:

labeling, by a computer, an object with one or more object terms that characterize the object;

constructing, by the computer, a social graph that represents an online social network, the social graph having vertices that represent respective members of the social network, and links that represent social connections between respective pairs of the members;

tagging, by the computer, each of the links with one or more link terms that represent common interests between two of the members whose vertices are connected by the link;

responsively to a comparison of the object terms and the link terms with which the links have been tagged, calculating, by the computer, respective distribution ranks for a plurality of the members; and

sending, by the computer, a message to one of the members of the social network suggesting that the member distribute the object to a subset of the members responsively at least in part to the distribution ranks.

In an embodiment, calculating the respective distribution ranks includes:

constructing, for the object, a distribution graph that includes a subgraph of the social graph including only those vertices and links of the social graph tagged with at least one of the social terms corresponding to at least one of the object terms; and

using the distribution graph to calculate the respective distribution ranks.

For some applications, tagging includes finding the common interests for each of the links responsively to previous distribution of one or more previous objects between the two of the members. Alternatively or additionally, tagging includes finding the common interests for each of the links responsively to a comparison of respective profiles of the two of the members. For some applications, tagging includes tagging each of the links with the link terms and one or more terms related to at least one of the link terms.

For some applications, the links include respective edges. Alternatively, the links include respective semantic graphs.

In an embodiment, the object includes an application.

There is further provided, in accordance with an embodiment of the present invention, apparatus including:

an interface; and

a processor, which is configured to label an object with one or more object terms that characterize the object; construct a social graph that represents an online social network, the social graph having vertices that represent respective members of the social network, and links that represent social connections between respective pairs of the members; tag each of the links with one or more link terms that represent common interests between two of the members whose vertices are connected by the link; responsively to a comparison of the object terms and the link terms with which the links have been tagged, calculate respective distribution ranks for a plurality of the members; and send, via the interface, a message to one of the members of the social network suggesting that the member distribute the object to a subset of the members responsively at least in part to the distribution ranks.

There is still further provided, in accordance with an embodiment of the present invention, a computer software including a tangible computer-readable medium in which program instructions are stored, which instructions, when read by a computer, cause the computer to label an object with one or more object terms that characterize the object; construct a social graph that represents an online social network, the social graph having vertices that represent respective members of the social network, and links that represent social connections between respective pairs of the members; tag each of the links with one or more link terms that represent common interests between two of the members whose vertices are connected by the link; responsively to a comparison of the object terms and the link terms with which the links have been tagged, calculate respective distribution ranks for a plurality of the members; and send a message to one of the members of the social network suggesting that the member distribute the object to a subset of the members responsively at least in part to the distribution ranks.

There is additionally provided, in accordance with an embodiment of the present invention, apparatus including:

means for labeling an object with one or more object terms that characterize the object;

means for constructing a social graph that represents an online social network, the social graph having vertices that represent respective members of the social network, and links that represent social connections between respective pairs of the members;

means for tagging each of the links with one or more link terms that represent common interests between two of the members whose vertices are connected by the link;

means for calculating, responsively to a comparison of the object terms and the link terms with which the links have been tagged, respective distribution ranks for a plurality of the members; and

means for sending a message to one of the members of the social network suggesting that the member distribute the object to a subset of the members responsively at least in part to the distribution ranks.

The present invention will be more fully understood from the following detailed description of embodiments thereof, taken together with the drawings, in which:

### BRIEF DESCRIPTION OF THE DRAWINGS

FIG. 1 is a schematic, pictorial illustration of a network environment including an application targeting system, in accordance with an embodiment of the present invention;

FIG. 2 is a flowchart schematically illustrating a method for targeting the distribution of an application, in accordance with an embodiment of the present invention;

FIG. 3 is a schematic illustration of an exemplary social graph, in accordance with an embodiment of the present invention;

FIG. 4 is a schematic illustration of an exemplary distribution graph, in accordance with an embodiment of the present invention; and

FIG. 5 is a schematic illustration of an exemplary social graph of users having user profiles, in accordance with an embodiment of the present invention.

### DETAILED DESCRIPTION OF EMBODIMENTS

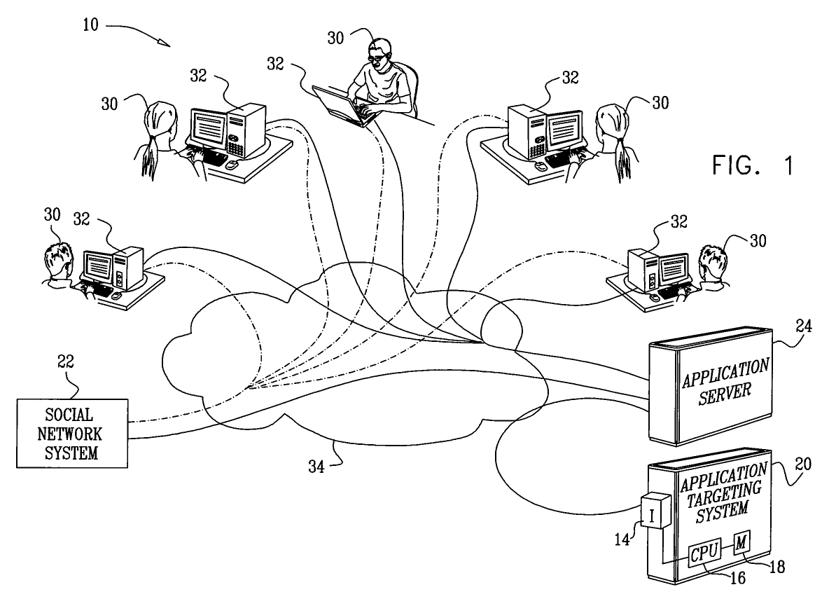

FIG. 1 is a schematic, pictorial illustration of a network environment 10 including an application targeting system 20, in accordance with an embodiment of the present invention. Application targeting system 20 comprises a communication interface 14, a central processing unit (CPU) 16, and a memory 18, which typically comprises a non-volatile memory, such as one or more hard disk drives, and/or a volatile memory, such as random-access memory (RAM). Network environment 10 further includes at least one social network system 22, and at least one application server 24. A plurality of users 30 use respective workstations 32, such as a personal computers, to remotely access social network system 22 and application server 24 via a wide-area network (WAN) 34, such as the Internet. For some applications, workstations 32 directly access application server 24 via WAN 34, while for other applications, the workstations access the application server via social network system 22. Alternatively or additionally, one or more of users 30 access social network system 22 and/or application server 24 via a local area network (LAN), or both a LAN and a WAN. For some applications, application targeting system 20, social network system 22, and/or application server 24 are operated by different entities, while for other applications, one or more of these are operated by the same entity.

For some applications, application targeting system 20 uses techniques described in: (a) International Patent Application PCT/US07/67103, which published as PCT Publication WO 07/124,430, (b) U.S. patent application Ser. No. 12/253,087, filed Oct. 16, 2008, and/or (c) in the other applications incorporated by reference hereinbelow.

Typically, application targeting system 20, social network system 22, and application server 24 comprise one or more respective standard computer servers with appropriate memory, communication interfaces and software for carrying out the functions prescribed by the present invention. This software may be downloaded to the systems in electronic form over a network, for example, or it may alternatively be supplied on tangible media, such as CD-ROM. Typically, a web browser running on each workstation 32 communicates with web servers of social network system 22 and application server 24. Each of workstations 32 comprises a central processing unit (CPU), system memory, a non-volatile memory such as a hard disk drive, a display, input and output means such as a keyboard and a mouse, and a network interface card (NIC). Alternatively, instead of workstations, the users use other devices, such as portable and/or wireless devices, to access the servers.

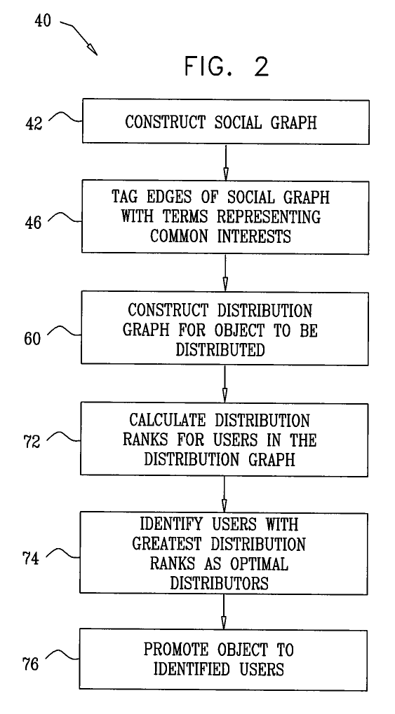

Reference is made to FIG. 2, which is a flowchart schematically illustrating a method 40 for targeting the distribution of an application, in accordance with an embodiment of the present invention. Application targeting system 20, including CPU 16 thereof, begins method 40 by constructing a social graph representing a social network, at a social graph construction step 42. The social graph typically has vertices that represent users 30, and links, such as edges, that represent social connections between users. Application targeting system 20, including CPU 16 thereof, typically constructs the social graph in part using information provided by social network system 22. Application targeting system 20 typically stores the social graph in memory 18 thereof.

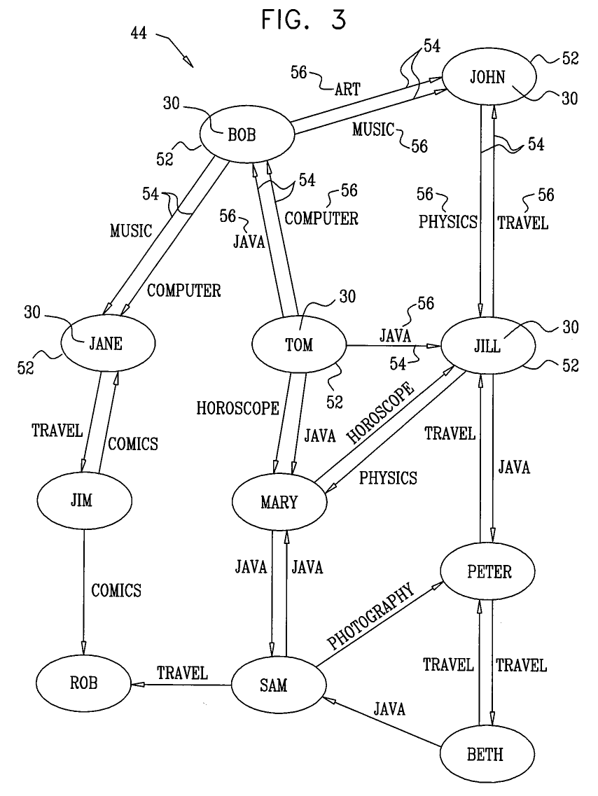

Reference is made to FIG. 3, which is a schematic illustration of an exemplary social graph 44, in accordance with an embodiment of the present invention. Social graph 44 represents social relationships among users 30 represented by respective vertices 52, as is known in the art of online social networking.

Reference is again made to FIG. 2. At a tag step 46 of method 40, application targeting system 20, including CPU 16 thereof, tags one or more edges 54 between vertices 52 with terms 56 that represent common interests between the users connected by the edges. For some applications, each of terms 56 is assigned a score, such as described hereinbelow.

In an embodiment of the present invention, application targeting system 20 tags edges 54 based on explicit application and/or content distribution and/or sharing among users 30. In online social networks, users can distribute or share applications (i.e., computer programs comprising a set of instructions) and content (e.g., videos) with other users. In the present application, including in the claims, an “object” includes both applications and content (such as media content), and the term “sharing” includes distributing and/or suggesting an object to another user, such as by explicitly suggesting that another user may be interested in the object (either to the distributor, host, or server of the object, or directly to the other user), or sending the object to another user. Alternatively, social network system 22 notifies users when their friends have installed, downloaded, or viewed an object, thereby indicating that the object is likely to be of interest.

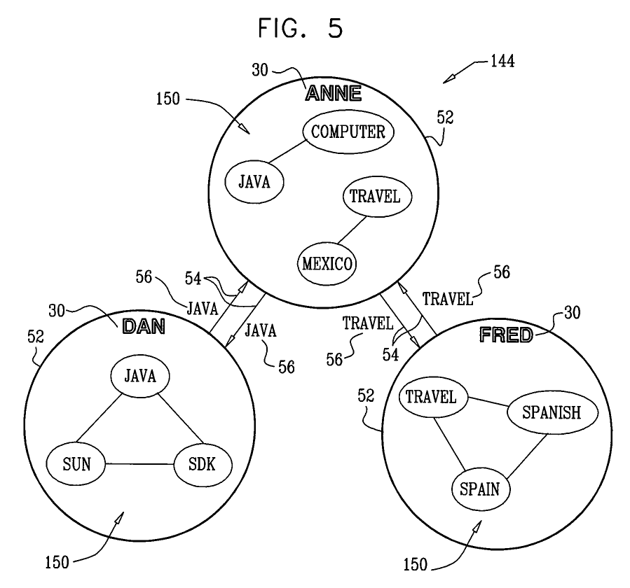

Application targeting system 20, including CPU 16 thereof, labels objects with one or more terms that characterize the object. (As used in the present application, including in the claims, the phrase “labeling the object” and similar phrases are to be understood to mean labeling a data element representative of the object, rather than the code or content of the object itself.) Such labeling is typically performed by the creator or host of the object, such as application server 24, and/or by application targeting system 20. For some applications, such labeling is performed manually. Alternatively or additionally, such labeling is performed implicitly. For some applications, such implicit labeling is performed using techniques described in the following patent applications, mutatis mutandis: U.S. application Ser. No. 12/023,564, filed Jan. 31, 2008, entitled, “Searchable interactive internet advertisements,” which published as US Patent Application Publication 2008/0215416, and/or U.S. Provisional Application 60/887,580, filed Jan. 31, 2007, entitled, “Searchable banner display and apparatus that enables exploring destination content prior to reaching it,” both of which are assigned to the assignee of the present application and are incorporated herein by reference. For example, an object profile (e.g., an object association graph) may be constructed for the object using some of the techniques described in these patent applications for constructing advertising profiles. The object profile may represent interactions between users and the object. Such interactions typically include, but are not limited to:
viewing of the object by a user, such as if the object comprises content, and/or running the object, such as if the application comprises an application. Terms from a profile of the user who views or runs the object are added to the object profile. The user profile may be constructed as described hereinbelow with reference to FIG. 5, or as described in one or more of the co-assigned patent applications incorporated hereinbelow by reference. For some applications, the user profile comprises an association graph, and only terms directly linked in the user association graph to one or more terms already included in the object profile are imported into the object profile. Alternatively or additionally, all or a larger portion of the terms in the object profile are imported, typically with highly damped weightings;
more complex interactions of a user with the object, such as when the object comprises an application. For example, such interactions may include queries entered into the object by the user, such as search queries. Terms are added to the object profile based on these interactions, such as using techniques described in the two above-referenced provisional patent applications regarding searchable internet advertisements; and/or
sharing by a user of the object with another user. When a first user shares the object with a second user, one or more terms of a profile of the first user are added to the object profile. Optionally, one or more terms from a profile of the second user are also added to the object profile, typically with damped scores. For some applications the user profiles comprise association graphs, and only terms directly linked in the user profile to one or more terms already included in the object profile are imported into the object profile. Alternatively or additionally, all or a larger portion of the terms in the object profile are imported, typically with highly damped weightings.

For some applications, object profiles are extended by importing terms that are related to the terms in the object profile. Such extension of the object profile enables inexact matches when constructing the distribution graph at distribution graph construction step 60 of method 40, described hereinbelow with reference to FIG. 2. For example, such additional terms may comprise synonyms (e.g., derived from a thesaurus or dictionary); cognitive synonyms, e.g. derived from WordNet® (Princeton University, Princeton, N.J.); or other related terms, e.g. derived from an encyclopedia or online wiki. For some applications, real-time analysis is applied to the terms in the profile to find related words. For example, the terms in the profile, either together and/or individually, may be entered as a search query into an online search engine, and terms that characterize the result listing may be added to the profile.

When a first user shares the object with a second user, application targeting system 20, including CPU 16 thereof, tags the edge 54 between the vertices 52 of the first and second users with the terms with which the object is labeled. For some applications, such tagging occurs regardless of whether the second user chooses to accept the shared object (e.g., download, install, open, read, or view the object), while for other applications, such tagging occurs only if the second user accepts the shared object. Alternatively, the system tags the edge regardless of whether the second user accepts the shared object, but assigns a higher score to the terms of objects that the second user accepts. Typically, such tagging is unidirectional in the direction of the sharing, as indicated by the arrows on edges 54 of social graph 44 shown in FIG. 3.

For example, assume that an application provides functionality for quick look-up of class definitions for the Java™ (Sun Microsystems, Inc., Santa Clara, Calif.) programming language. This application is labeled with the term “Java.” A first user, Tom, shown in FIG. 3, suggests to a second user, Jill, that this application may be of interest. Jill accepts the suggestion, and adds the application to her social network profile. System 20 thus adds the term “Java,” with which the application is labeled, to the edge 54 between the vertices 52 of Tom and Jill. Similarly, if Jill were to send a video regarding Java programming techniques to Tom, and, optionally, Tom were to view the video, the system would add the term(s) characterizing the video to the edge between Tom and Jill.

In an embodiment of the present invention, instead of comprising single-term edges, each of the links between the vertices of social graph 44 comprises a semantic graph, which comprises one or more terms have relationships with one another. For some applications, the semantic graph is represented as an association graph, in which each of the vertices includes one of the terms, and the relationships between the terms are represented by respective edges linking the vertices. For some application, each of the object profiles comprises a plurality of terms represented as an association graph; when such an object is distributed, the system, rather than importing each term of the object profile into separate edges, imports the structure and scores of the object association graph into the link between the users, typically with heavy damping of the edge scores of the object association graph.

For some applications, in addition to importing one or more terms from the object profile into the linking semantic graph, the system imports one or more terms from the sending and/or receiving user's profile, and links such terms to at least one of the terms in the linking semantic graph. For example, the system may import terms from the sender's or the receiving user's profile that are directly linked to one or more terms of the object profile. Alternatively, the system may perform a comparison of the sender's and the receiver's profiles, and import common terms (optionally, only those terms that are linked with at least one of the terms of the object profile in at least one of the users' profiles, or in both). Alternatively or additionally, the system imports terms from previous distribution events between the two users, optionally only if such terms include and/or are linked to at least one of the terms in the object profile.

Typically, application targeting system 20 assigns scores to terms 56. Upon each distribution event, the system increments the appropriate edges labeled with the terms of the distributed object, by a score associated with the distribution event. For some applications, such as when limited or no information is available about the users, the system assigns the same score to each distribution event. For example, when a first user distributes a first object labeled with the term “Java” to a second user, the system may create an edge between the first and second users, and assign a score of 1 to the edge. If the first user subsequently distributes a second, different object labeled with the term “Java” to the second user, the system may increment the score of the existing edge by 1, such that the score of the edge is now 2. For some applications, the system damps the scores over time, in order to give greater weight to more recent distribution events.

For some applications in which the user has a user profile, for example as described hereinbelow with reference to FIG. 5, the system scores a distribution event responsively to the user profile. For example, the system may assign a greater score if the user profile includes one or more terms with which the object is labeled, or may assign the score responsively to the scores of such terms in the user profile. For some applications in which the user profile comprises an association graph, as described hereinbelow with reference to FIG. 5, the system assigns the score responsively to a total of the edge scores (including any self-referential edge scores) of all terms in the user profile directly connected to the terms that are included in the object profile. Optionally, the system alternatively or additionally scores the distribution event responsively to a profile of the user receiving the distributed object, such as using the techniques described immediately above for the sender's profile.

In an embodiment of the present invention, application targeting system 20 implicitly tags edges 54, as described hereinbelow with reference to FIG. 5.

Reference is yet again made to FIG. 2. At a distribution graph construction step 60 of method 40, application targeting system 20 constructs a distribution graph for an object to be distributed. The object is typically different from the objects that have been used to tag social graph 44 at step 46 of method 40. The object is labeled with one or more terms that characterize the object. Such labeling is typically performed by the creator or host of the object, such as application server 24, and/or by application targeting system 20, such as using techniques described hereinabove for labeling objects. The distribution graph for the object comprises a subgraph of social graph 44 including only those vertices 52 and edges 54 of the social graph tagged with at least one of the terms with which the object has been labeled. For some applications, the system allows inexact matches, such as by extending the terms of the object profile, as described hereinabove, and/or the terms of social graph, such as using the techniques described hereinabove for extending the terms of the object profile, mutatis mutandis.

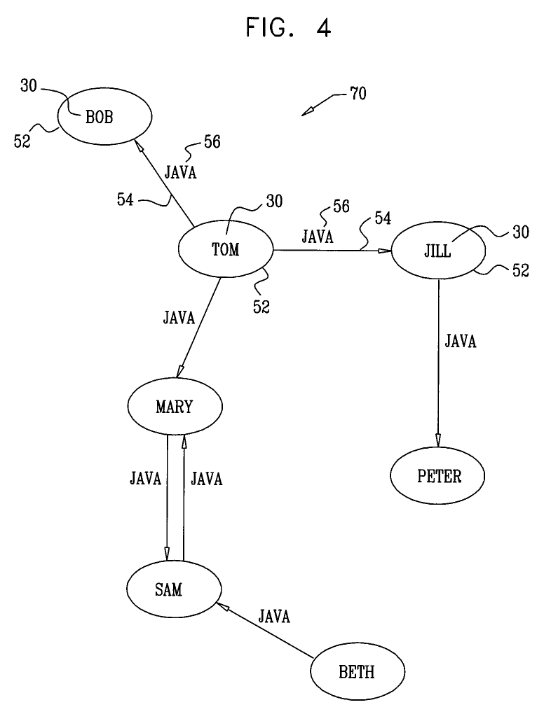

Reference is made to FIG. 4, which is a schematic illustration of an exemplary distribution graph 70, in accordance with an embodiment of the present invention. For example, assume that an application provides functionality for generating an alert when a new version of the Java programming language is released, and the object has been labeled with the terms “Java” and “version.” Distribution graph 70 thus includes the vertices 52 having at least one edge 54 labeled with “Java” or “version.”

Reference is again made to FIG. 2. At a distribution ranking step 72 of method 40, application targeting system 20, including CPU 16 thereof, calculates a distribution rank for each of users 30 included in distribution graph 70. When calculating the distribution rank for a user, the system typically takes into account the number of other users directly and indirectly connected to the user. Table 1 shows exemplary distribution ranks for the users included in exemplary distribution graph 70, calculated using the techniques described hereinbelow with reference to Matrices 1 and 2:

TABLE 1

| User | Rank |
|---|---|
| Bob | 0.14 |
| Tom | 0.75 |
| Jill | 0.29 |
| Mary | 0.14 |
| Sam | 0.29 |
| Peter | 0.14 |
| Beth | 0.45 |

Additional techniques for calculating the distribution ranks will be evident to those skilled in the art who have read the present application, and are within the scope of the present invention.

At an optimal distributors identification step 74 of method 40, application targeting system 20 identifies one or more of users 30 that represent good targets for distribution, such as because they have the greatest distribution ranks. In the example shown in Table 1, Tom has the greatest distribution rank, and Beth has the second greatest distribution rank. For applications in which the object is to be distributed by a distributor other than application targeting system 20, such as application server 24 (FIG. 1), application targeting system 20, including CPU 16 thereof, sends a message, via communication interface 14 thereof, to the distributor indicating the suggested distributors. The distributor of the object targets these users as ideal initial distributors (seeds) for the object, at an object promotion step 76. The distributor may promote the object to these users by, for example:
sending the object to these users;
advertising the object to these users (e.g., in respective objects, such as applications, that the users have previously downloaded or installed, either from the distributor or another entity); and/or
incentivize these users to distribute the object.

Application targeting system 20 does not necessarily identify the highest-ranking users as the best distributors. For some applications, the system may take into account the topology of social graph 44 in order to increase the diffusion of the distributors in the graph. For example, many of the highest-ranking users may be clustered in one or more small communities, such that targeting these users may result in a relatively limited distribution of the object among such users and their friends. For some applications, the system excludes from its suggestions direct neighbors of selected distributors, or neighbors within a certain degree of separation, in order to include less related lower-ranking distributors.

The targeting techniques of embodiments of the present invention may be particularly useful in environments in which advertisements or viral suggestions are constrained. For example, some online social networks place limits on the number of messages that a given distributor can send in a given period of time. Some object distributors have a large base of user-installed applications that can be used for advertising the object. Since these applications have limited effective advertising space, the distributor may use the distribution ranks of a plurality of objects the distributor desires to virally distribute in order to best target each of the objects to users most likely to download and redistribute it. In addition, a distributor may compensate another distributor of objects to distribute the object to the identified target users.

In an embodiment of the present invention, application targeting system 20 constructs and/or tags the edges of social graph 44 based on object distribution information received from a plurality of separate object distributors.

In an embodiment of the present invention, an object distributor decides which objects to develop and/or distribute based on the key words that would characterize the object. Before investing resources in the development or distribution, the object distributor tests the potential distribution strength of the object by finding the distribution ranks achieved by the keywords. The distribution ranks are often good indicators of the potential virality of the object, i.e., how quickly and widely the object may be virally distributed, and/or the likelihood of strong viral distribution.

In an embodiment of the present invention, application targeting system 20 provides an application programming interface (API) to object distributors, which enables the distributors to provide distribution data to system 20, and to receive distribution rankings of objects based on their keywords.

In an embodiment of the present invention, application targeting system 20 generates a set of suggested key words with high distribution potential, and shares this set with application distributors, such as via the API. The application distributors may develop applications accurately characterized by these suggested key words, with the expectation that such applications have a greater likelihood of having high virality. For example, the system may generate the set of suggested key words by extracting more common terms from social graph 44 and/or user profiles, finding the best distributing users for these terms, summing the scores for the top n best distributing users, and comparing the resulting sums for the different terms.

Reference is made to FIG. 5, which is a schematic illustration of an exemplary social graph 144 of users 30 having user profiles 150, in accordance with an embodiment of the present invention. Application targeting system 20 uses social graph 144 and user profiles 150 to implicitly tag edges 54 with terms 56 that represent common interests between users connected by the edges. Such tagging is typically bidirectional, i.e., includes separate edges in both directions, as indicated in social graph 144 shown in FIG. 5. For some applications, the system performs such implicit tagging in addition to tagging based on such inter-user distribution, as described hereinabove with reference to FIGS. 2-4. Scores of the edges implicitly tagged are typically damped with respect to the scores of the edges based on inter-user distribution. Implicit tagging scores are typically added to scores of edges also tagged based on inter-user distribution.

In this embodiment, each of the users is assigned a user profile, which typically includes terms that characterize interests of the user. The terms are typically determined responsively to interactions of the user with one or more websites, advertisement, applications, and/or social networks. For example, such interactions may include search interactions. Alternatively or additionally, the interactions may include interactions of the user with an object, such as an application, that has been distributed to the user. Alternatively or additionally, the profile includes other information about the user determined explicitly or implicitly, for example derived from search logs, browsing history, referrer URLs, and/or recent session patterns of the user.

In an embodiment of the present invention, the interactions of a user with an object include a request to share the object with another user (e.g., the object may comprise an application or content, such as textual or video content). Optionally, the system provides a greater weight to a share interaction if the recipient accepts or views the shared object. For example, assume that Anne of social graph 144 shares a calculator application with Fred, and the calculator application is labeled with the terms “math,” “calculate,” and “subtraction.” These terms are added to Anne's profile, and, optionally, to Fred's profile as well.

For some applications, the profile comprises an association graph associated with the second user, such as a personal association graph (PAG) or a session association graph. Each association graph comprises one or more vertices, each of which is linked to one or more other vertices by respective edges. Furthermore, a vertex may be linked to itself by an edge in some instances. Each vertex of an associate graph includes a single term, which comprises one or more keywords. Typically, when a term includes a plurality of keywords, the keywords are order-sensitive. In the art, and in the applications assigned to the assignee of the present application that are incorporated hereinbelow by reference, “vertices” are sometimes referred to as “nodes,” and “edges” are sometimes referred to as “arcs” or “links.” For some applications, the system constructs the profile using techniques described in above-mentioned International Patent Application PCT/US07/67103, and/or in the other applications incorporated by reference hereinbelow.

Alternatively, the user profile comprises a list (e.g., a ranked list), a vector, a set of sets, or a non-associative multi-dimensional matrix (e.g., three or more dimensions).

Application targeting system 20 tags edges 54 with terms 56 that are common to pairs of users. For example, the system may tag edge 54 between vertices 52 of Dan and Anne with the term “Java,” because this term is included in profiles 150 of both of these users 30. Typically, the system only tags edges that connect users having some previous relationship that may lead them to share object with one another. For example, the relationship may include: (a) a previous sharing of an object; (b) a declared friendship, such as indicated by an online social network of which they are members; (c) a previous communication between the users, such as the sending of a message or an e-mail; and/or (d) a previous indirect sharing of an object, such as when a user downloads an object after being notified that a friend has downloaded the object.

The system typically assigns scores to the tagged edges responsively to the scores of the common terms in the connected users' profiles. For example, the system may take the product or the sum of the self-referential scores of the common term in the two users' profiles, and damp the resulting value.

Reference is made to Matrices 1 and 2, which are exemplary matrices used for scoring social graphs, in accordance with an embodiment of the present invention. Exemplary matrix 1 represents exemplary social graph 44, described hereinabove with reference to FIG. 3. In this example, a score of 1 is assumed for each edge.

MATRIX 1

| | Bob | John | Jane | Tom | Jill | Jim | Mary | Peter | Rob | Sam | Beth |
|---|---|---|---|---|---|---|---|---|---|---|---|
| Bob | | 1 | 1 | | | | | | | | |
| John | | | | | | | | | | | |
| Jane | | | | | | | | | | | |
| Tom | 1 | | | | 1 | | 1 | | | | |
| Jill | | | | | | | 1 | 1 | | | |
| Jim | | | 1 | | | | | | 1 | | |
| Mary | | | | | | | | | | 1 | |
| Peter | | | | | | | | | | | 1 |
| Rob | | | | | | | | | | | |
| Sam | | | | | | | 1 | 1 | 1 | | |
| Beth | | | | | | | | 1 | | 1 | |

In an embodiment of the present invention, application targeting system 20 calculates ranks of each of the users represented by social graph 44 and Matrix 1 by first defining a matrix A based on Matrix 1, as shown in Matrix 2:

$$MATRIX 2$$

$$A = \begin{matrix}0 & 1 & 1 & 0 & 0 & 0 & 0 & 0 & 0 & 0 & 0 \\ 0 & 0 & 0 & 0 & 0 & 0 & 0 & 0 & 0 & 0 & 0 \\ 0 & 0 & 0 & 0 & 0 & 0 & 0 & 0 & 0 & 0 & 0 \\ 1 & 0 & 0 & 0 & 1 & 0 & 1 & 0 & 0 & 0 & 0 \\ 0 & 0 & 0 & 0 & 0 & 0 & 1 & 1 & 0 & 0 & 0 \\ 0 & 0 & 1 & 0 & 0 & 0 & 0 & 0 & 1 & 0 & 0 \\ 0 & 0 & 0 & 0 & 0 & 0 & 0 & 0 & 0 & 1 & 0 \\ 0 & 0 & 0 & 0 & 0 & 0 & 0 & 0 & 0 & 0 & 1 \\ 0 & 0 & 0 & 0 & 0 & 0 & 0 & 0 & 0 & 0 & 0 \\ 0 & 0 & 0 & 0 & 0 & 0 & 1 & 1 & 1 & 0 & 0 \\ 0 & 0 & 0 & 0 & 0 & 0 & 0 & 1 & 0 & 1 & 0\end{matrix}$$

The system then solves the eigenvector equation

[(1−ε)A+εU]\vec{x}=λ\vec{x} (Equation 1)

in which U is a matrix of all ones, and ε a small positive number. The system sets the ranking equal to the eigenvector \vec{x} that corresponds to the largest eigenvalue λ. The coefficients of the eigenvector \vec{x} represent the individual scores of the users in the graph.

In this example, the ranks of each user are as shown in the following table:

TABLE 2

| User | Rank |
|---|---|
| Bob | 0.13 |
| John | 0.06 |
| Jane | 0.06 |
| Tom | 0.49 |
| Jill | 0.38 |
| Jim | 0.12 |
| Mary | 0.28 |
| Peter | 0.31 |
| Rob | 0.06 |
| Sam | 0.42 |
| Beth | 0.46 |

The word “document,” as used in the present application, including the claims, is to be understood broadly as referring to any digital unit of information, including, but not limited to, files (e.g., containing text, media, or hyperlinks), Web pages, newsgroup postings, and e-mails, which can be stored electronically on a computer or a network. The word “webpage,” as used in the present application, including the claims, is to be understood broadly as referring to any document transmitted over a private or public computer network, such as the Internet, for presentation in a viewer application, such as a browser. The word “term,” as used in the present application, including the claims, includes one or more keywords.

The phrase “association graph,” as used herein, including in the claims, includes any data structure that conceptually includes vertices linked by edges, regardless of the nomenclature used to describe the data structure, or how it may be represented, stored, structured, and/or manipulated in memory and/or another storage medium. For some applications, more than one edge links some pairs of vertices. For some applications, the association graph comprises a hypergraph, i.e., a single edge connects more than two vertices. For some applications, the association graph is not directed, i.e., the edges do not include a direction, while for other applications, the association graph is at least partly directed, i.e., at least a portion of the edges include a direction. For some applications, by linking a plurality of directed edges, the search system develops multi-vertex paths of connectivity among vertices.

In some embodiments of the present invention, the distributed applications comprise widgets, which comprise portable pieces of code that can be installed and executed within a webpage or otherwise on a user's personal computer.

Techniques of embodiments of the present invention typically improve the efficiency of propagating objects in social networks, and conserve the use of computer resources.

Embodiments of the present invention described herein can take the form of an entirely hardware embodiment, an entirely software embodiment or an embodiment including both hardware and software elements. In an embodiment, the invention is implemented in software, which includes but is not limited to firmware, resident software, microcode, etc.

Furthermore, the embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium.

Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Typically, the operations described herein that are performed by application targeting system 20 transform the physical state of memory 18, which is a real physical article, to have a different magnetic polarity, electrical charge, or the like depending on the technology of the memory that is used.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. The system can read the inventive instructions on the program storage devices and follow these instructions to execute the methodology of the embodiments of the invention.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

Computer program code for carrying out operations of the present invention may be written in any combination of one or more programming languages, including an object oriented programming language such as Java, Smalltalk, C++ or the like and conventional procedural programming languages, such as the C programming language or similar programming languages.

It will be understood that each block of the flowchart shown in FIG. 2, and combinations of blocks in the flowchart, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart blocks.

The scope of the present invention includes embodiments described in the following applications, which are assigned to the assignee of the present application and are incorporated herein by reference. In an embodiment, techniques and apparatus described in one or more of the following applications are combined with techniques and apparatus described herein:
International Patent Application PCT/US07/67103, filed Apr. 20, 2007, entitled, “Search techniques using association graphs,” which published as PCT Publication WO 07/124,430;
U.S. patent application Ser. No. 11/633,461, filed Dec. 5, 2006, entitled, “A multi-directional and auto-adaptive relevance and search system and methods thereof,” which published as US Patent Application Publication 2007/0250500;
U.S. Provisional Patent Application 60/793,253, filed Apr. 20, 2006, entitled, “Methods for using association graphs in search engines”;
U.S. Provisional Patent Application 60/796,188, filed May 1, 2006, entitled, “Apparatus and methods thereof for search engine personalization”;
U.S. Provisional Patent Application 60/829,136, filed Oct. 11, 2006, entitled, “Apparatus and methods thereof for search phrase refinement”;
U.S. Provisional Patent Application 60/829,135, filed Oct. 11, 2006, entitled, “Apparatus and methods thereof for using explicit query refinements to tune search results ranking factors”;
U.S. Provisional Patent Application 60/829,132, filed Oct. 11, 2006, entitled, “Apparatus and methods thereof for adaptive ranking mechanism using association graphs and contextual analysis”;
U.S. Provisional Patent Application 60/886,193, filed Jan. 23, 2007, entitled, “Multi-directional and auto-adaptive relevance and search system and methods thereof”;
U.S. Provisional Patent Application 60/887,580, filed Jan. 31, 2007, entitled, “Searchable banner display and apparatus that enables exploring destination content prior to reaching it”;
U.S. Provisional Patent Application 60/741,902, filed in January 2006, entitled, “A multi-directional and auto-adaptive relevance and search system and methods thereof”;
U.S. patent application Ser. No. 11/846,213, filed Aug. 28, 2007, entitled, “Search phrase refinement by search term replacement”;
U.S. patent application Ser. No. 12/023,564, filed Jan. 31, 2008, entitled, “Searchable interactive internet advertisements,” which published as US Patent Application Publication 2008/0215416; and
U.S. patent application Ser. No. 12/253,087, filed Oct. 16, 2008, entitled, “Techniques for ranking search results.”

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A computer-implemented method comprising:
labeling, by a computer, an object with one or more object terms that characterize the object;
constructing, by the computer, a social graph that represents an online social network, the social graph having vertices that represent respective members of the social network, and links that represent social connections between respective pairs of the members;
tagging, by the computer, each of the links with one or more link terms that represent common interests between two of the members whose vertices are connected by the link;
responsively to a comparison of the object terms and the link terms with which the links have been tagged, calculating, by the computer, respective distribution ranks for a plurality of the members; and
sending, by the computer, a message to one of the members of the social network suggesting that the member distribute the object to a subset of the members responsively at least in part to the distribution ranks.

2. The method according to claim 1, wherein calculating the respective distribution ranks comprises:
constructing, for the object, a distribution graph that comprises a subgraph of the social graph including only those vertices and links of the social graph tagged with at least one of the social terms corresponding to at least one of the object terms; and
using the distribution graph to calculate the respective distribution ranks.

3. The method according to claim 1, wherein tagging comprises finding the common interests for each of the links responsively to previous distribution of one or more previous objects between the two of the members.

4. The method according to claim 1, wherein tagging comprises finding the common interests for each of the links responsively to a comparison of respective profiles of the two of the members.

5. The method according to claim 1, wherein tagging comprises tagging each of the links with the link terms and one or more terms related to at least one of the link terms.

6. The method according to claim 1, wherein the links comprise respective edges.

7. The method according to claim 1, wherein the links comprise respective semantic graphs.

8. The method according to claim 1, wherein the object comprises an application.

9. Apparatus comprising:
an interface; and
a processor, which is configured to label an object with one or more object terms that characterize the object; construct a social graph that represents an online social network, the social graph having vertices that represent respective members of the social network, and links that represent social connections between respective pairs of the members; tag each of the links with one or more link terms that represent common interests between two of the members whose vertices are connected by the link; responsively to a comparison of the object terms and the link terms with which the links have been tagged, calculate respective distribution ranks for a plurality of the members; and send, via the interface, a message to one of the members of the social network suggesting that the member distribute the object to a subset of the members responsively at least in part to the distribution ranks.

10. The apparatus according to claim 9, wherein the processor is configured to calculate the respective distribution ranks by constructing, for the object, a distribution graph that comprises a subgraph of the social graph including only those vertices and links of the social graph tagged with at least one of the social terms corresponding to at least one of the object terms; and using the distribution graph to calculate the respective distribution ranks.

11. The apparatus according to claim 9, wherein the processor is configured to find the common interests for each of the links responsively to previous distribution of one or more previous objects between the two of the members.

12. The apparatus according to claim 9, wherein the processor is configured to find the common interests for each of the links responsively to a comparison of respective profiles of the two of the members.

13. The apparatus according to claim 9, wherein the processor is configured to tag each of the links with the link terms and one or more terms related to at least one of the link terms.

14. The apparatus according to claim 9, wherein the object comprises an application.

15. A computer software comprising a tangible computer-readable medium in which program instructions are stored, which instructions, when read by a computer, cause the computer to label an object with one or more object terms that characterize the object; construct a social graph that represents an online social network, the social graph having vertices that represent respective members of the social network, and links that represent social connections between respective pairs of the members; tag each of the links with one or more link terms that represent common interests between two of the members whose vertices are connected by the link; responsively to a comparison of the object terms and the link terms with which the links have been tagged, calculate respective distribution ranks for a plurality of the members; and send a message to one of the members of the social network suggesting that the member distribute the object to a subset of the members responsively at least in part to the distribution ranks.

16. The product according to claim 15, wherein the instructions cause the computer to calculate the respective distribution ranks by constructing, for the object, a distribution graph that comprises a subgraph of the social graph including only those vertices and links of the social graph tagged with at least one of the social terms corresponding to at least one of the object terms; and using the distribution graph to calculate the respective distribution ranks.

17. The product according to claim 15, wherein the instructions cause the computer to find the common interests for each of the links responsively to previous distribution of one or more previous objects between the two of the members.

18. The product according to claim 15, wherein the instructions cause the computer to find the common interests for each of the links responsively to a comparison of respective profiles of the two of the members.

19. The product according to claim 15, wherein the object comprises an application.

20. Apparatus comprising:
means for labeling an object with one or more object terms that characterize the object;
means for constructing a social graph that represents an online social network, the social graph having vertices that represent respective members of the social network, and links that represent social connections between respective pairs of the members;
means for tagging each of the links with one or more link terms that represent common interests between two of the members whose vertices are connected by the link;
means for calculating, responsively to a comparison of the object terms and the link terms with which the links have been tagged, respective distribution ranks for a plurality of the members; and
means for sending a message to one of the members of the social network suggesting that the member distribute the object to a subset of the members responsively at least in part to the distribution ranks.
